(19) United States
(12) Patent Application Publication
(10) Pub. No.: US 2024/0258734 A1
(43) Pub. Date: Aug. 1, 2024

(54) ELECTRICAL CONNECTOR

(71) Applicants: Daniel MILNER, Peterborough (GB); Michael Wallace Edwin HURFORD, Peterborough (GB)

(72) Inventors: Daniel MILNER, Peterborough (GB); Michael Wallace Edwin HURFORD, Peterborough (GB)

(21) Appl. No.: 18/289,436

(22) PCT Filed: May 5, 2022
(86) PCT No.: PCT/EP2022/062177

§ 371 Date: Nov. 3, 2023

(30) Foreign Application Priority Data
May 14, 2021 (GB) 2106935.6

(51) Int. Cl. H01R 13/422; H01R 13/187; H01R 13/26; H01R 13/58; H01R 13/627; H01R 24/28; H02G 3/14; H02G 3/16

(52) U.S. Cl. CPC H01R 13/4226; H01R 13/187; H01R 13/26; H01R 13/5829; H01R 13/6272; H01R 24/28; H02G 3/14; H02G 3/16

(57) ABSTRACT

An electrical junction box (10) comprising: a housing (110) defining a chamber (120) with an entry port (130) for receiving an electrical cable; and at least one connection terminal (170) provided within the chamber (120) and configured to engage an exposed conductor end of the electrical cable, the at least one connection terminal (170) comprising a clamping mechanism (180) for connecting a conductor of the electrical cable to the electrical junction box (10); wherein the housing (110) comprises a main body portion (150) and a lid (160) movably coupled to the main body portion (150), the main body portion (150) and the lid (160) together forming the chamber (120) and the entry port (130), the lid (160) being movable relative to the main body portion (150) from an open position in which the chamber (120) is accessible and a closed position in which the chamber (120) is covered, wherein movement of the lid (160) from the open position to the closed position causes the clamping mechanism (180) to clamp the exposed end of the electrical cable.

The present invention relates to electrical connectors and particularly, but not exclusively, to an electrical junction box formed by a pair of electrical connectors.

Junction boxes of various shapes and sizes are known in the art and used to connect electrical cables embedded into walls and ceilings of a building. For the purposes of the present disclosure, the term “junction box” is defined to mean any enclosure with a lid or cover in which electrical wires can be safely connected.

Push-fit junction boxes, comprising a pair of connectable boxes with removable lids covering enclosed screw-fit connection terminals, are also known in the art. Advantageously, push-fit junction boxes are useful in situations where regulations require electrical fittings (e.g. lighting) to be replaceable without disrupting hardwired connections. However, just like conventional junction boxes, push-fit junction boxes are time-consuming to wire.

The present applicant has identified the need for an improved junction box that addresses, or at least alleviates, problems associated with the prior art.

In accordance with a first aspect of the present invention, there is provided an electrical junction box comprising: a housing (e.g. electrically insulative housing) defining a chamber with an entry port for receiving an electrical cable; and at least one connection terminal provided within the chamber and configured to engage an exposed conductor end of the electrical cable, the at least one connection terminal comprising a clamping mechanism for (e.g. mechanically and electrically) connecting a conductor of the electrical cable to the electrical junction box; wherein the housing comprises a main body portion and a lid movably coupled (e.g. pivotally coupled) to the main body portion, the main body portion and the lid together forming the chamber and the entry port, the lid being movable relative to the main body portion from an open position in which the chamber is accessible and a closed position in which the chamber is covered, wherein movement of the lid from the open position to the closed position causes the clamping mechanism to clamp the exposed end of the electrical cable.

In one embodiment, the entry port defines an entry port axis.

In one embodiment, the entry port is accessible from above when the lid is in the open position (e.g. to allow the electrical cable to be inserted into the entry port in a direction perpendicular to the entry port axis).

In one embodiment, the chamber comprises first and second opposed end walls.

In one embodiment, the chamber comprises first and second opposed side walls.

In one embodiment, the first end wall defines the entry port.

In one embodiment, the second end wall defines at least one terminal aperture configured to receive an exposed conductor end of an electrical cable.

In one embodiment, the at least one terminal aperture defines a conductor insertion axis.

In one embodiment, the at least one terminal aperture is tapered (e.g. with a cross-sectional area that decreases with increased distance from the entry port.

In one embodiment, the conductor insertion axis of the at least one aperture is inclined relative to the entry port axis.

In one embodiment, the conductor insertion axis is inclined relative to the entry port axis by 35-55°.

In one embodiment, the conductor insertion axis is inclined relative to the entry port axis by substantially 45°.

In one embodiment, the second end wall is inclined relative to the entry port axis.

In one embodiment, the second end wall is inclined relative to the entry port axis by substantially the same angle as the conductor insertion axis.

In one embodiment, the main body portion defines a lower surface of the chamber.

In one embodiment, the conductor insertion axis and/or the second end wall is inclined relative to the lower surface of the chamber.

In one embodiment, the conductor insertion axis and/or the second end wall is inclined relative to the lower surface of the chamber by 35-55°.

In one embodiment, the conductor insertion axis and/or the second end wall is inclined relative to the lower surface of the chamber by substantially 45°.

In one embodiment, the clamping mechanism comprises: a frame; and a spring member mounted on the frame.

In one embodiment, the spring member is configured to be displaced by a lever mechanism associated with the lid.

In one embodiment, the lever mechanism includes a cam surface operative to displace the spring member as the lid pivots between the open and closed position.

In one embodiment, the frame is electrically conductive.

In one embodiment, the spring member is electrically conductive.

In one embodiment, the spring member comprises first and second arms connected by a central folded section (e.g. U-shaped spring member).

In one embodiment, the frame comprises an upright wall defining an aperture for receiving the exposed end of the conductor to be clamped.

In one embodiment, the aperture is configured to receive end portions of one or more (e.g. both) of the first and second arms of the spring member.

In one embodiment, the frame comprises a longitudinal surface extending from the upright wall for engaging the first (e.g. inner) arm of the spring member.

In one embodiment, the aperture is provided in a part of the frame that is fixed relative to the housing (e.g. in fixed frame part).

In one embodiment, the chamber includes a cable sleeve lock (e.g. located on the lower surface of the chamber).

In one embodiment, the cable sleeve lock is provided adjacent to the first end wall.

In one embodiment, the cable sleeve lock is configured to allow movement of a cable sleeve of the electrical cable towards the second end wall but substantially resists movement of the cable sleeve away from the second end wall (e.g. to prevent the cable sleeve from being pulled out through the entry port).

In one embodiment, the cable sleeve lock comprises a pair of laterally spaced resiliently biased gates provided on opposed sides of the entry port axis.

In one embodiment, the lid and main body portion have interengageable profiles (e.g. interengageable snap-fit profiles).

In one embodiment, the interengageable profiles of the lid and main body portion are configured to be released by a tool (e.g. to prevent accidental release).

In one embodiment, the cable comprises a plurality of separately insulated (e.g. sheathed) conductors (e.g. live, neutral, earth conductors) provided within an outer sleeve.

In one embodiment, the at least one connection terminal comprises a plurality of connection terminals (e.g. three connection terminals), each connection terminal comprising a separate clamping mechanism for (e.g. mechanically and electrically) connecting a separate conductor of the electrical cable to the electrical junction box.

In one embodiment, the movement of the lid from the open position to the closed position causes each of the clamping mechanisms to clamp an exposed end of the electrical cable received in its respective connection terminal.

In the case that the second wall defines at least one terminal aperture, the at least one terminal aperture comprises a plurality of (e.g. two or more, e.g. three or more) separate terminal apertures.

In one embodiment, each connection terminal is associated with a different one of the plurality of terminal apertures.

In one embodiment, the lid has a single movable lid section associated with the full plurality of connection terminals (e.g. so that movement of the single moveable lid section activates multiple clamp mechanisms).

However, in another embodiment the lid may comprise a plurality of independently movable lid sections, each lid section being associated with a different subset of the plurality of connection terminals.

In one embodiment, the chamber defines a first (e.g. upper) connection bay for receiving a first electrical cable and the housing defines a second chamber with a second entry port for defining a second (e.g. lower) connection bay for receiving a second electrical cable (hereinafter a dual-chamber housing), the second chamber being formed by the main body and a second lid.

In one embodiment, the electrical junction box is a two-part junction box (e.g. push-fit mains connector box), wherein the housing and the at least one connection terminal are provided in a first junction box part and the first junction box part is connectable (e.g. mechanically and electrically) to a second junction box part by a (e.g. push-fit) connector interface system.

In one embodiment, the second junction box part is configured to connect the first junction box part to a single cable.

In one embodiment, the second junction box part is a distribution hub (e.g. multi-connector distribution hub for connecting with multiple connector parts).

In accordance with a second aspect of the present invention, there is provided an electrical connector module comprising: a housing (e.g. electrically insulative housing) defining a chamber with an entry port for receiving an electrical cable; a connector interface for mating with a complementary connector (e.g. complementary connector provided on another electrical connector module or on a distribution hub), the connector interface comprising an electrically conductive connector element for engaging a corresponding connector element of the complementary connector; and at least one connection terminal provided within the chamber and configured to engage an exposed conductor end of the electrical cable and provide an electrical connection between the electrical cable and the connector interface, the at least one connection terminal comprising a clamping mechanism for (e.g. mechanically and electrically) connecting a conductor of the electrical cable to the electrical connector module; wherein the housing comprises a main body portion and a lid movably coupled (e.g. pivotally coupled) to the main body portion, the main body portion and the lid together forming the chamber and the entry port, the lid being movable relative to the main body portion from an open position in which the chamber is accessible and a closed position in which the chamber is covered, wherein movement of the lid from the open position to the closed position causes the clamping mechanism to clamp the exposed end of the electrical cable.

In one embodiment, the entry port defines an entry port axis.

In one embodiment, the entry port is accessible from above when the lid is in the open position (e.g. to allow the electrical cable to be inserted into the entry port in a direction perpendicular to the entry port axis).

In one embodiment, the chamber comprises first and second opposed end walls.

In one embodiment, the chamber comprises first and second opposed side walls.

In one embodiment, the first end wall defines the entry port.

In one embodiment, the second end wall defines at least one terminal aperture configured to receive an exposed conductor end of an electrical cable.

In one embodiment, the at least one terminal aperture defines a conductor insertion axis.

In one embodiment, the at least one terminal aperture is tapered (e.g. with a cross-sectional area that decreases with increased distance from the entry port.

In one embodiment, the conductor insertion axis of the at least one aperture is inclined relative to the entry port axis.

In one embodiment, the conductor insertion axis is inclined relative to the entry port axis by 35-55°.

In one embodiment, the conductor insertion axis is inclined relative to the entry port axis by substantially 45°.

In one embodiment, the second end wall is inclined relative to the entry port axis.

In one embodiment, the second end wall is inclined relative to the entry port axis by substantially the same angle as the conductor insertion axis.

In one embodiment, the main body portion defines a lower surface of the chamber.

In one embodiment, the conductor insertion axis and/or the second end wall is inclined relative to the lower surface of the chamber.

In one embodiment, the conductor insertion axis and/or the second end wall is inclined relative to the lower surface of the chamber by 35-55°.

In one embodiment, the conductor insertion axis and/or the second end wall is inclined relative to the lower surface of the chamber by substantially 45°.

In one embodiment, the chamber includes a cable sleeve lock (e.g. located on the lower surface of the chamber).

In one embodiment, the cable sleeve lock is provided adjacent to the first end wall.

In one embodiment, the cable sleeve lock is configured to allow movement of a cable sleeve of the electrical cable towards the second end wall but substantially resists movement of the cable sleeve away from the second end wall (e.g. to prevent the cable sleeve from being pulled out through the entry port).

In one embodiment, the cable sleeve lock comprises a pair of laterally spaced resiliently biased gates provided on opposed sides of the entry port axis.

In one embodiment, the cable sleeve lock comprises first and second pairs of cooperating laterally spaced resiliently biased gates provided on opposed sides of the entry port axis.

In one embodiment, the lid and main body portion have interengageable profiles (e.g. interengageable snap-fit profiles).

In one embodiment, the interengageable profiles of the lid and main body portion are configured to be released by a tool (e.g. to prevent accidental release).

In one embodiment, the cable comprises a plurality of separately insulated (e.g. sheathed) conductors (e.g. live, neutral, earth conductors) provided within an outer sleeve.

In one embodiment, the at least one connection terminal comprises a plurality of connection terminals (e.g. three connection terminals), each connection terminal comprising a separate clamping mechanism for (e.g. mechanically and electrically) connecting a separate conductor of the electrical cable to the electrical junction box.

In one embodiment, the movement of the lid from the open position to the closed position causes each of the clamping mechanisms to clamp an exposed end of the electrical cable received in its respective connection terminal.

In the case that the second wall defines at least one terminal aperture, the at least one terminal aperture comprises a plurality of (e.g. two or more, e.g. three or more) separate terminal apertures.

In one embodiment, each connection terminal is associated with a different one of the plurality of terminal apertures.

In one embodiment, the lid has a single movable lid section associated with the full plurality of connection terminals (e.g. so that movement of the single moveable lid section activates multiple clamp mechanisms).

However, in another embodiment the lid may comprise a plurality of independently movable lid sections, each lid section being associated with a different subset of the plurality of connection terminals.

In one embodiment, the clamping mechanism of the or each connection terminal comprises: a frame; and a spring member mounted on the frame.

In one embodiment, the spring member is configured to be displaced by a lever mechanism associated with the lid.

In one embodiment, the lever mechanism includes a cam surface operative to displace the spring member as the lid pivots between the open and closed position.

In one embodiment, the frame is electrically conductive.

In one embodiment, the spring member is electrically conductive.

In one embodiment, the spring member comprises first and second arms connected by a central folded section (e.g. U-shaped spring member).

In one embodiment, the frame comprises an upright wall defining an aperture for receiving the exposed end of the conductor to be clamped.

In one embodiment, the aperture is configured to receive end portions of one or more (e.g. both) of the first and second arms of the spring member.

In one embodiment, the frame comprises a longitudinal surface extending from the upright wall for engaging the first (e.g. inner) arm of the spring member.

In one embodiment, the aperture is provided in a part of the frame that is fixed relative to the housing (e.g. in fixed frame part).

In one embodiment, the electrically conductive connector element extends from one lateral side of the frame.

In one embodiment, the electrically conductive connector element of the connector interface is integrally formed as part of the frame.

In one embodiment, the electrically conductive connector element defines a longitudinal axis.

In one embodiment, the longitudinal axis of the electrically conductive connector element defines a mating axis (e.g. axis along which the connector interface is configured to mate with the complementary connector).

In one embodiment, the electrically conductive connector element is a blade member (e.g. elongate blade member) defining a longitudinal axis.

In one embodiment, the blade member is resiliently biased (e.g. a resiliently biased blade member).

In one embodiment, the blade member comprises a flat blade (e.g. elongate flat blade).

In one embodiment, the blade member has a substantially rectangular cross section (e.g. in a plane perpendicular to the longitudinal axis).

In one embodiment, the blade member has a lateral engagement surface.

In one embodiment, the lateral engagement surface is substantially planar.

In one embodiment, the lateral engagement surface is substantially rectangular.

In one embodiment, the chamber defines a first (e.g. upper) connection bay for receiving a first electrical cable and the housing defines a second chamber with a second entry port for defining a second (e.g. lower) connection bay for receiving a second electrical cable (hereinafter a dual-chamber housing), the second chamber being formed by the main body and a second lid.

In the case of a dual-chamber housing, the clamping mechanism may comprise a second spring member (e.g. second U-shaped spring member) mounted on the frame.

In one embodiment, the frame comprises first and second upright walls (e.g. upper and lower uprights walls) extending in opposed directions from a central hub.

In one embodiment, each of the first and second upright walls define an aperture for receiving exposed conductor ends of first and second electrical cables respectively).

In one embodiment, the central hub defines first and second opposed longitudinal surfaces (e.g. upper and lower longitudinal surfaces).

In one embodiment, the electrically conductive connector element (e.g. blade member) extends from the central hub (e.g. extends from a region of the central hub located between the opposed longitudinal surfaces).

In one embodiment, the electrically conductive connector element (e.g. blade member) extends from one lateral side of the hub.

In one embodiment, the hub defines a recess for coupling the frame to the housing.

In one embodiment, the recess is located between the first and second longitudinal surfaces.

In one embodiment, the electrically conductive connector element (e.g. blade member) extends from one lateral side of the recess.

In the case of a clamping mechanism including first and second spring members, the first spring member may be configured to be displaced by a first lever mechanism associated with a first lid of the connector module.

In one embodiment, the second spring member may be configured to be displaced by a second lever mechanism associated with the second lid of the connector.

In one embodiment, the first lever mechanism includes a first cam surface operative to displace the first spring member as the first lid pivots between an open and closed position.

In one embodiment, the second lever mechanism includes a second cam surface operative to displace the second spring member as the second lid pivots between an open and closed position.

In one embodiment, the connector interface comprises a blade housing.

In one embodiment, the blade housing comprises an open chamber housing the first blade member with a side channel adjacent the blade member for slidably receiving a tip of a corresponding blade member of the complementary connector.

In one embodiment, the side channel is configured to permit entry of the tip of the corresponding blade member of the complementary connector alongside the blade member (such that the lateral engagement surface of the blade member engages a corresponding engagement surface of the blade of the complementary connector) whilst displacing the blade member from its undisplaced position.

In one embodiment, the side channel is configured such that entry of the tip of the blade member of the complementary connector causes flexure of the tip of the blade member.

In one embodiment, the blade housing further defines a guide surface (e.g. sloped guide surface) positioned at an entrance to the side channel to guide the tip of the blade member of the complementary connector into the side channel.

In accordance with a third aspect of the present invention, there is provided an electrical connector module comprising: a housing (e.g. electrically insulative housing); a connector interface for mating with a complementary connector (e.g. complementary connector provided on another electrical connector module or on a distribution hub), the connector interface comprising an electrically conductive connector element for engaging a corresponding connector element of the complementary connector; and a connection terminal provided within the housing and configured to engage an exposed conductor end of an electrical cable and provide an electrical connection between the electrical cable and the connector interface; wherein the connection terminal comprises a clamping mechanism including: a frame; and a spring member mounted on the frame; wherein the electrically conductive connector element of the connector interface is integrally formed as part of the frame.

In one embodiment, the frame is electrically conductive.

In one embodiment, the spring member is electrically conductive.

In one embodiment, the spring member comprises first and second arms connected by a central folded section (e.g. U-shaped spring member).

In one embodiment, the frame comprises an upright wall defining an aperture for receiving the exposed end of the conductor to be clamped.

In one embodiment, the aperture is configured to receive end portions of one or more (e.g. both) of the first and second arms of the spring member.

In one embodiment, the frame comprises a longitudinal surface extending from the upright wall for engaging the first (e.g. inner) arm of the spring member.

In one embodiment, the aperture is provided in a part of the frame that is fixed relative to the housing (e.g. in fixed frame part).

In one embodiment, the electrically conductive connector element extends from one lateral side of the frame.

In one embodiment, the spring member is configured to be displaced by a lever mechanism (e.g. lever mechanism associated with a lid of the electrical connector module).

In one embodiment, the lever mechanism includes a cam surface operative to displace the spring member as the lever mechanism pivots between an open and closed position.

In one embodiment, the electrically conductive connector element defines a longitudinal axis.

In one embodiment, the longitudinal axis of the electrically conductive connector element defines a mating axis (e.g. axis along which the connector interface is configured to mate with the complementary connector).

In one embodiment, the electrically conductive connector element is a blade member (e.g. elongate blade member) defining a longitudinal axis.

In one embodiment, the blade member is resiliently biased (e.g. a resiliently biased blade member).

In one embodiment, the blade member comprises a flat blade (e.g. elongate flat blade).

In one embodiment, the blade member has a substantially rectangular cross section (e.g. in a plane perpendicular to the longitudinal axis).

In one embodiment, the blade member has a lateral engagement surface.

In one embodiment, the lateral engagement surface is substantially planar.

In one embodiment, the lateral engagement surface is substantially rectangular.

In one embodiment, the clamping mechanism comprises a second spring member (e.g. second U-shaped spring member) mounted on the frame.

In one embodiment, the frame comprises first and second upright walls (e.g. upper and lower uprights walls) extending in opposed directions from a central hub.

In one embodiment, each of the first and second upright walls define an aperture for receiving exposed conductor ends of first and second electrical cables respectively).

In one embodiment, the central hub defines first and second opposed longitudinal surfaces (e.g. upper and lower longitudinal surfaces).

In one embodiment, the electrically conductive connector element (e.g. blade member) extends from the central hub (e.g. extends from a region of the central hub located between the opposed longitudinal surfaces).

In this way, a dual-cable electrical connector module is provided with a common frame/electrically conductive connector element providing an electrical connection for common conductors (e.g. live, neutral, earth conductors) of a pair of cables terminated by the electrical connector module.

In one embodiment, the electrically conductive connector element (e.g. blade member) extends from one lateral side of the hub.

In one embodiment, the hub defines a recess for coupling the frame to the housing.

In one embodiment, the recess is located between the first and second longitudinal surfaces.

In one embodiment, the electrically conductive connector element (e.g. blade member) extends from one lateral side of the recess.

In the case of a clamping mechanism including first and second spring members, the first spring member may be configured to be displaced by a first lever mechanism (e.g. first lever mechanism associated with a first lid of the connector).

In one embodiment, the second spring member may be configured to be displaced by a second lever mechanism (e.g. second lever mechanism associated with a second lid of the connector)

In one embodiment, the first lever mechanism includes a first cam surface operative to displace the first spring member as the first lever mechanism pivots between an open and closed position.

In one embodiment, the second lever mechanism includes a second cam surface operative to displace the second spring member as the second lever mechanism pivots between an open and closed position.

In one embodiment, the connector interface comprises a blade housing.

In one embodiment, the blade housing comprises an open chamber housing the first blade member with a side channel adjacent the blade member for slidably receiving a tip of a corresponding blade member of the complementary connector.

In one embodiment, the side channel is configured to permit entry of the tip of the corresponding blade member of the complementary connector alongside the blade member (such that the lateral engagement surface of the blade member engages a corresponding engagement surface of the blade of the complementary connector) whilst displacing the blade member from its undisplaced position.

In one embodiment, the side channel is configured such that entry of the tip of the blade member of the complementary connector causes flexure of the tip of the blade member.

In one embodiment, the blade housing further defines a guide surface (e.g. sloped guide surface) positioned at an entrance to the side channel to guide the tip of the blade member of the complementary connector into the side channel.

In one embodiment, the electrical connector module is an electrical connector module in accordance with (e.g. any embodiment of) the second aspect of the present invention.

In accordance with a fourth aspect of the present invention, there is provided an electrical connector system comprising: a first electrical connector part defining a first connector of a connector interface system (e.g. push-fit connector interface system) and a second electrical connector part defining a second connector of the connector interface system; wherein: the first connector comprises a first blade member (e.g. first elongate blade member) defining a first lateral engagement surface and the second connector comprises a second blade member (e.g. second elongate blade member) defining a second lateral engagement surface, the first and second connectors being configured such that the first and second lateral engagement surfaces engage one another as the first and second connectors move from an disconnected configuration to a connected configuration.

In one embodiment, the first blade member defines a longitudinal axis (e.g. first longitudinal axis).

In one embodiment, the longitudinal axis of the first blade member defines a mating axis (e.g. axis along which the first connector is configured to mate with the second connector).

In one embodiment, the first blade member is a flat blade (e.g. elongate flat blade).

In one embodiment, the first blade member is a resiliently biased blade member.

In one embodiment, the first blade member has a substantially rectangular cross section.

In one embodiment, the first lateral engagement surface is substantially planar.

In one embodiment, the first lateral engagement surface is substantially rectangular.

In one embodiment, the second blade member defines a second longitudinal axis.

In one embodiment, the second blade member is an elongate flat blade (e.g. elongate flat blade).

In one embodiment, the second blade member is a resiliently biased blade member.

In one embodiment, the second blade member has a substantially rectangular cross section.

In one embodiment, the second lateral engagement surface is substantially planar.

In one embodiment, the first lateral engagement surface is substantially rectangular.

In one embodiment, the first electrical connector part is a first electrical connector module (e.g. first electrical junction box module of a two-part electrical junction box or some other type of two-part connector system). For example, the first electrical connector part may be an electrical connector module in accordance with the second or third aspects of the present invention.

In one embodiment, the second electrical connector part is a second electrical connector module (e.g. second electrical junction box module of a two-part electrical junction box or some other type of two-part connector system). For example, the second electrical connector part may be an electrical connector module in accordance with (e.g. any embodiment of) the second or third aspects of the present invention.

In one embodiment, the first electrical connector part is a distribution hub (e.g. multi-connector distribution hub for connecting with multiple connector parts).

In one embodiment, the second electrical connector part is a distribution hub (e.g. multi-connector distribution hub for connecting with multiple connector parts).

In one embodiment, the first connector comprises a first blade housing for housing the first blade member.

In one embodiment, the first blade housing comprises an open chamber housing the first blade member with a side channel adjacent the first blade member for slidably receiving a tip of the second blade member of the second connector.

In one embodiment, the side channel is configured to permit entry of the tip of the second blade member alongside the first blade member (such that the first and second lateral engagement surfaces engage) whilst displacing the first blade member from its undisplaced position.

In one embodiment, the side channel is configured such that entry of the tip of the second blade member causes flexure of the tip of the first blade member.

In one embodiment, the first blade housing further defines a guide surface (e.g. sloped guide surface) positioned at an entrance to the side channel to guide the tip of the second blade member into the side channel.

In one embodiment, the second connector comprises a second blade housing for housing the second blade member.

In one embodiment, the first and second blade housing are configured to engage as the first and second connectors move from the disconnected configuration to an engagement configuration (the engaged configuration being an intermediate configuration between the disconnected configuration and the connected configuration in which the first and second lateral engagement surfaces engage to form an electrical connection).

In one embodiment, the first and second blade housings together define a plug portion and a socket portion for receiving the plug portion.

In one embodiment, the plug portion is provided on the second blade housing and the socket portion is provided on the first blade housing.

In another embodiment, the plug portion is provided on the first blade housing and the socket portion is provided on the second blade housing.

In one embodiment, the first and second blade housings further comprise interengageable profiles (e.g. interengageable snap-fit profiles) configured to maintain a mechanical connection between the first and second electrical connector parts.

In one embodiment, the interengageable profiles of the first and second blade housings are configured to be released by a tool (e.g. to prevent accidental release).

An embodiment of the present invention will now be described by way of example with reference to the accompanying drawings in which:

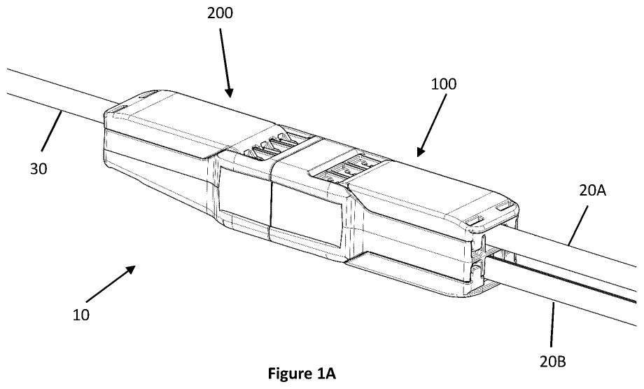

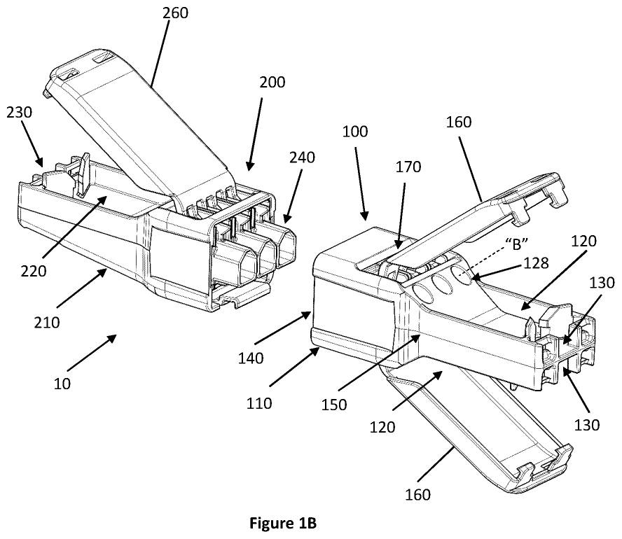

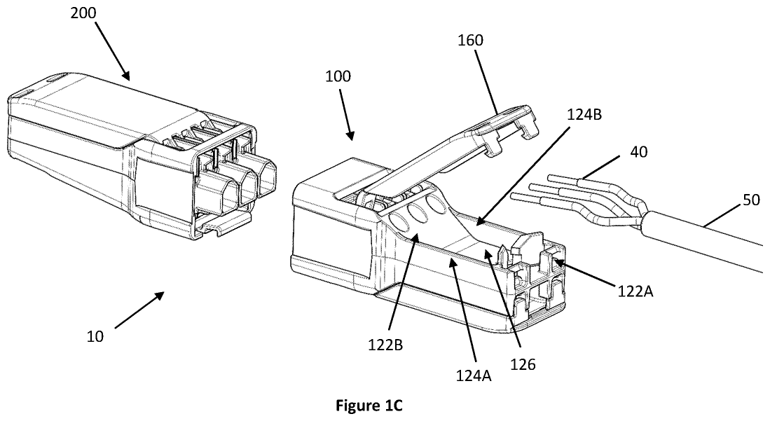

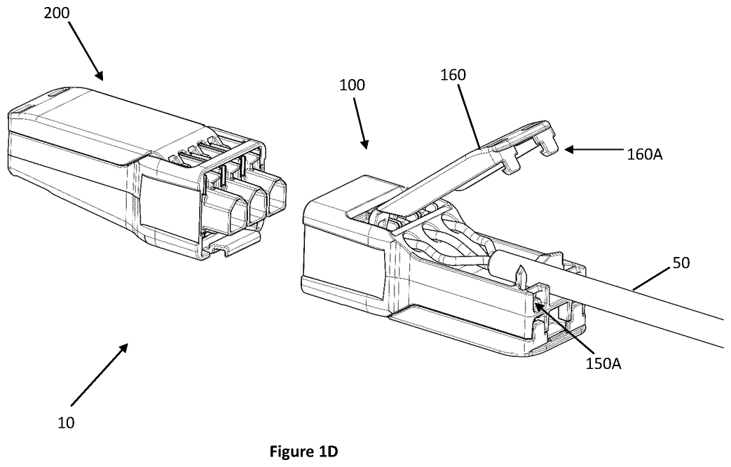

FIG. 1A is a schematic perspective view of a two-part electrical junction box in accordance with an embodiment of the present invention including first and second electrical connector modules shown in a connected configuration with their lids in a closed position;

FIG. 1B is a schematic perspective view of the electrical junction box of FIG. 1A with the first and second electrical connector modules shown in a disconnected configuration and their lids in an open position;

FIGS. 1C and 1D are schematic perspective views of the electrical junction box of FIG. 1A with the first and second electrical connector modules shown in a disconnected configuration illustrating connection of a cable to an upper connection bay of the first electrical connector module;

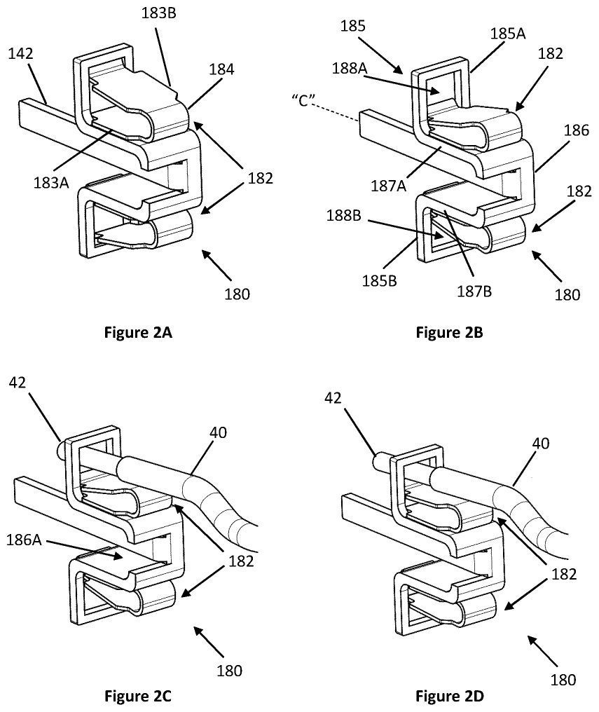

FIGS. 2A-2D are schematic perspective views of a combined clamping/connector interface component of the electrical junction box of FIG. 1A;

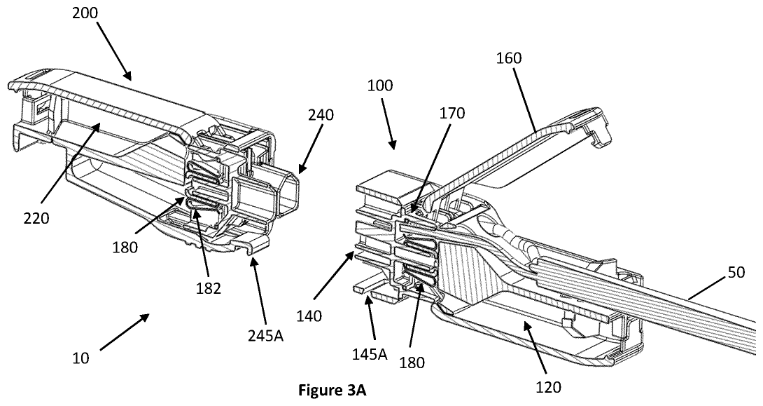

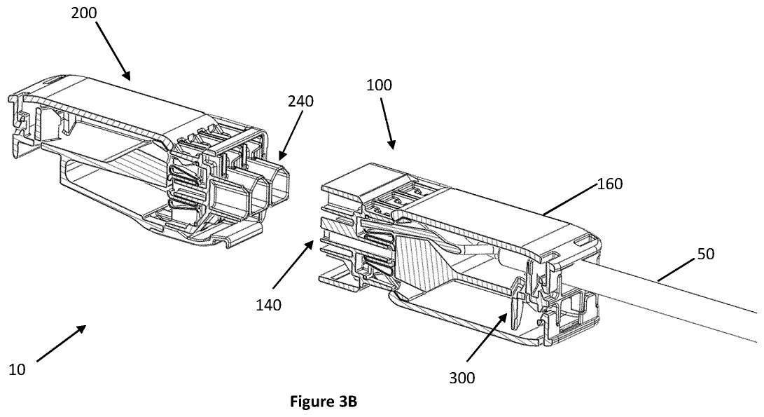

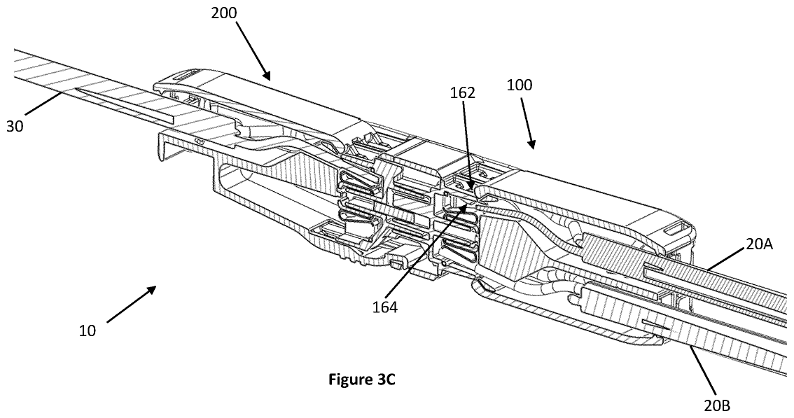

FIG. 3A is a schematic perspective cross-sectional view of the electrical junction box of FIG. 1A with the first and second electrical connector modules shown in a disconnected configuration and a cable installed in the upper connection bay of the first electrical connector module with the lid in the open position;

FIG. 3B is a schematic perspective cross-sectional view of the electrical junction box of FIG. 1A with the first and second electrical connector modules shown in a disconnected configuration and a cable installed in the upper connection bay of the first electrical connector module with the lid in the closed position;

FIG. 3C is a schematic perspective cross-sectional view of the electrical junction box of FIG. 1A with the first and second electrical connector modules shown in a connected configuration and cables installed in the upper and lower connection bays of the first electrical connector module and a load cable installed in the bay of the second electrical connector module;

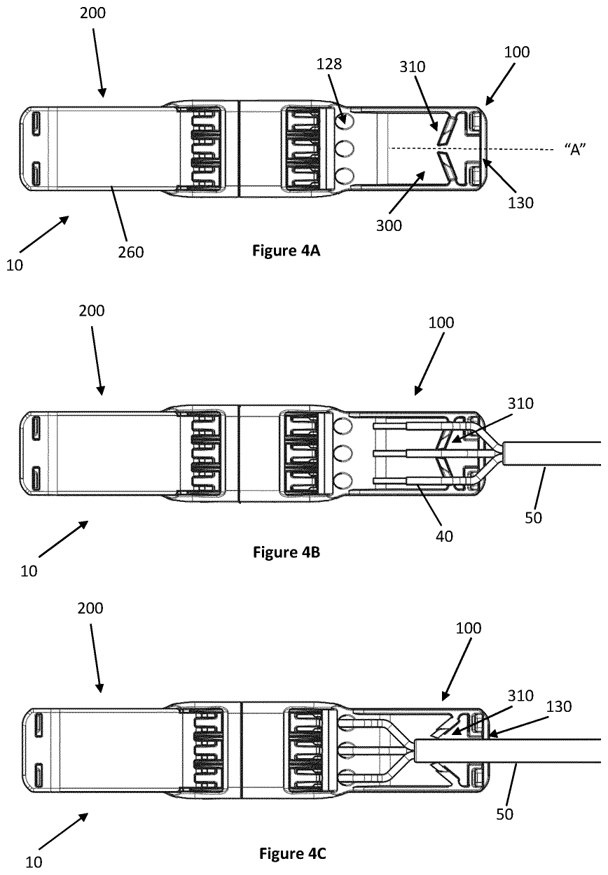

FIGS. 4A-4C are schematic plan views of the electrical junction box of FIG. 1 with the first and second electrical connector modules shown in the connected configuration illustrating operation of locking gates of the first connector part;

FIGS. 5A-5C are schematic underside, cross-sectional and side views respectively of the electrical junction box of FIG. 1 with the first and second electrical connector modules shown in the disconnected configuration;

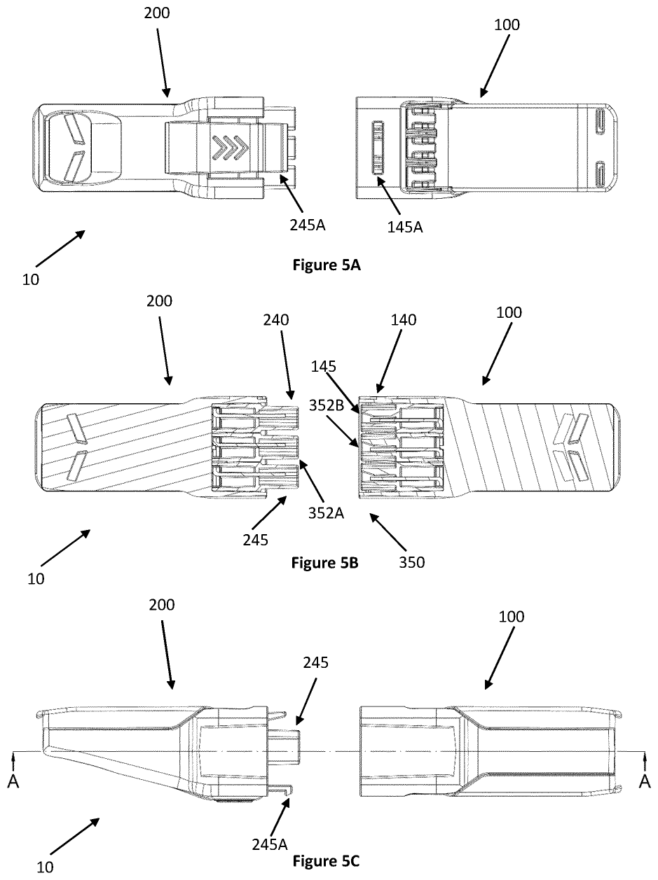

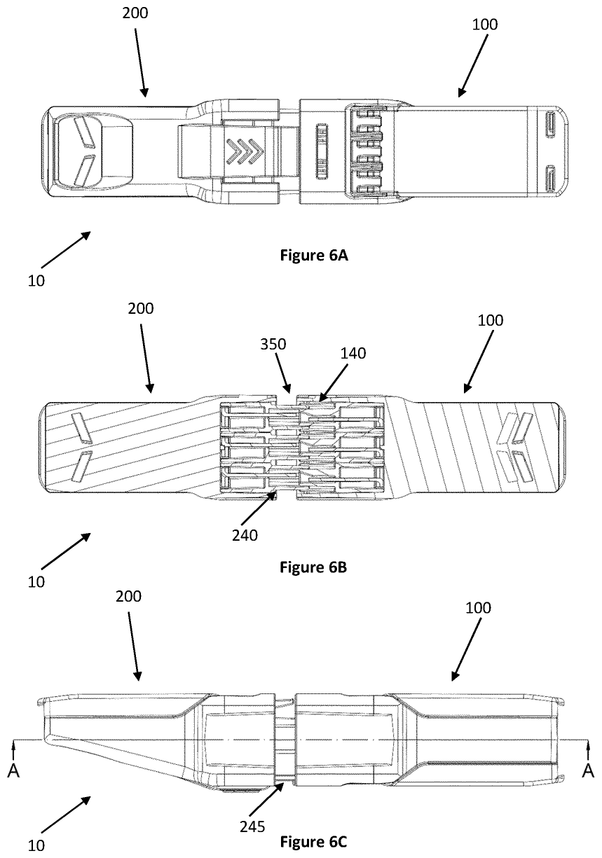

FIGS. 6A-6C are schematic underside, cross-sectional and side views respectively of the electrical junction box of FIG. 1 with the first and second electrical connector modules shown in an engaged configuration;

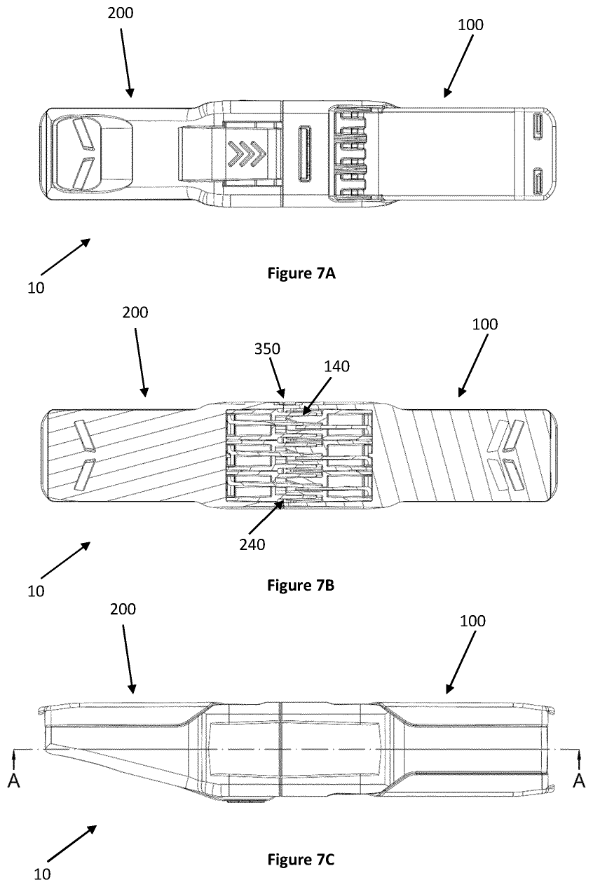

FIGS. 7A-7C are schematic underside, cross-sectional and side views respectively of the electrical junction box of FIG. 1 with the first and second electrical connector modules shown in the connected configuration;

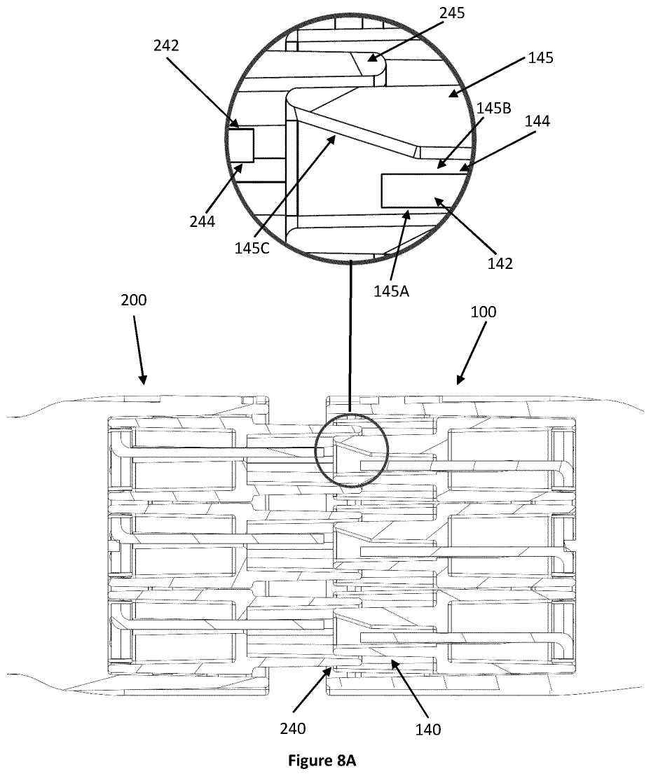

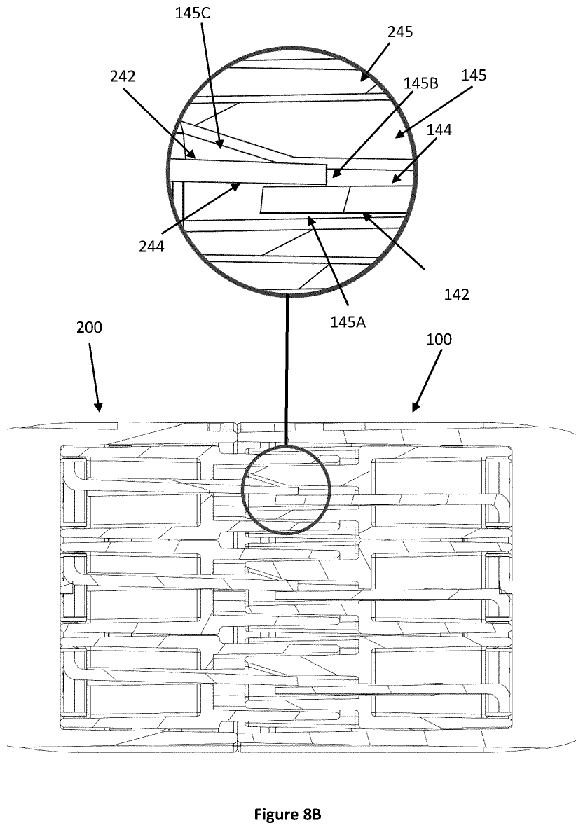

FIG. 8A is a close-up schematic cross-sectional view of connector interface parts of the first and second electrical connector modules when the first and second electrical connector modules are in the engaged configuration; and

FIG. 8B is a close-up schematic cross-sectional view of connector interface parts of the first and second electrical connector modules when the first and second electrical connector modules are in the connected configuration.

FIGS. 1A-D illustrate a push-fit two-part electrical junction box 10 comprising first and second electrical connector modules 100, 200.

First electrical connector module 100 has a dual bay configuration with two inputs for connecting loop in and loop out cables 20A, 20B. Second connector part 200 has a single-bay configuration with one output for connecting a load cable 30. In this illustrated embodiment each cable 20A, 20B, 30 comprises three separately insulated conductors 40 (e.g. live, neutral, earth conductors) provided within an outer sleeve 50. However, the invention may be scaled to accommodate cables containing fewer or more conductors depending upon the intended application.

With reference to FIGS. 1B-1D, first electrical connector 100 comprises: an electrically insulative housing 110 defining first and second chambers 120 each associated with a corresponding entry port 130 defining an entry port axis “A”; and a connector interface 140. Second electrical connector 200 comprises: an electrically insulative housing 210 defining a chamber 220 associated with an entry port 230; a connector interface 240.

Housing 110 comprises a main body portion 150 and a first and second lids 160 pivotally coupled to the main body portion 150, the main body portion 150 and the lids 160 together forming the respective chambers 120 and entry ports 130, the lids 160 being pivotable relative to the main body portion 150 from an open position in which chambers 120 are accessible and a closed position in which chambers 120 are covered.

Each chamber 120 comprises first and second opposed end walls 122A, 122B, first and second opposed side walls 124A, 124B and a lower surface 126. The first end wall 122A (which is defined by the main body portion and the lid) defines entry port 130. The second end wall 122B (which is defined by the main body portion alone) defines a set of three tapered terminal apertures 128 each associated with a respective one of three (live, neutral and earth) connection terminals 170. Each tapered terminal aperture 128 defines a conductor insertion axis “B” and has a cross-sectional area that decreases with increased distance from its respective entry port 130.

The second end wall 122B and the conductor insertion axis “B” of each tapered terminal aperture 128 is inclined relative to the entry port axis “A”/lower surface 126 of the chamber by substantially 45°.

Each set of three connection terminals 170 is configured to engage exposed conductor ends 42 of conductors 40 of electrical cable 20A, 20B and provide an electrical connection between the electrical cable 20A, 20B and the connector interface 140.

With reference to FIGS. 2A-2D, each connection terminal 170 comprises a clamping mechanism 180 for mechanically and electrically connecting a conductor 40 of the electrical cable 20A, 20B to the electrical junction box 10.

As illustrated, clamping mechanism 180 comprises first and second electrically conductive U-shaped spring members 182 (each comprising first and second arms 183A, 183B connected by a central folded section 184) mounted on an electrically conductive frame 185 to which an elongate electrically conductive connector blade 142 of the connector interface 140 is integrally formed.

Frame 185 comprises fixed first and second uprights walls 185A, 185B extending in opposed directions from a central hub 186 and first and second opposed longitudinal surfaces 187A, 187B extending from each upright wall 185A, 185B for engaging the first arm 183A of each spring member 182. Each of the upper and lower upright walls 185A, 185B define an aperture 188A, 188B for receiving exposed conductor ends 42 of first and second electrical cables 20A, 20B respectively.

As illustrated, each aperture 188A, 188B is configured to receive end portions of first and second arms 183A, 183B of its respective spring member 182.

Hub 186 defines a recess 186A located between the first and second longitudinal surfaces 187A, 187B for coupling the frame 185 to housing 110. Elongate electrically conductive blade member 142 extends from one lateral side of the recess 186A.

Each spring member 182 is configured to be displaced by a respective lever mechanism 162 associated with the lid 160. Each lever mechanism 162 takes the form of an arm projecting from the lid pivot axis and includes a cam surface 164 operative to displace its respective spring member 182 as the lever mechanism 162 pivots with lid 160 between an open and closed position.

In FIG. 2A upper lid 160 is closed and upper spring member 182 is under no external load and is secure inside aperture 188A of frame 185.

In FIG. 2B upper lid 160 is open and upper spring member 182 is compressed by cam surface 164 of the lid 160 to create an opening for exposed conductor end 42.

In FIG. 2C upper lid 160 is open and upper spring member 182 is compressed by cam surface 164 of the lid allowing exposed conductor end 42 to be inserted between upper spring member and frame 185.

In FIG. 2D upper lid 160 is closed and upper spring member 182 is under no external load. Exposed conductor end 42 is clamped between upper spring member 182 and frame 185 using only the material properties of the spring member.

With reference to FIGS. 4A-4C, each chamber 120 includes a cable sleeve lock 300 located on the lower surface 126 of the chamber 120 adjacent to the first end wall 122A.

Cable sleeve lock 300 comprises a pair of cooperating laterally spaced resiliently biased lock gates 310 provided on opposed sides of the entry port axis “A”. As illustrated, the pair of the lock gates 310 are angled inwards and work in tandem to secure the cable 20A, 20B.

As show in FIG. 4B, conductor ends 42 of the cable 20A, 20B are positioned ready to be inserted into the terminal apertures 128. In FIG. 4C the outer cable sleeve 50 (which is now forward of the lock gates 310) is pushed downwards. The lock gates 310 open to fit the diameter of the cable. The diameter of the outer cable sleeve 50 prevents the lock gates 310 from closing/returning to the moulded position and creates a tension on the cable 20A, 20B. The harder the cable 20A, 20B is pulled, the more tension is placed on the cable keeping it in place.

Each lid 160 and main body portion 150 have interengageable hook and catch snap-fit profiles 160A, 150A. Once interengaged, the snap-fit profiles 160A, 150A are configured to be released by a tool (e.g. screwdriver tip) to prevent accidental release of the lid.

Second electrical connector 200 shares substantially the same construction as first electrical connector 100 and comprises housing 210 comprising a main body portion 250, a lid 260 pivotally coupled to the main body portion 250, the main body portion 250 and the lid 260 together forming chambers 220 and entry port 230, the lid 260 being pivotable relative to the main body portion 250 from an open position in which chamber 220 is accessible and a closed position in which chamber 220 is covered.

Chamber 220 includes all of the same parts as chambers 120 including connection terminals 170, three inclined tapered terminal apertures 128 and associated clamping mechanisms 180. The only difference being that the clamping mechanism 180 of chamber 220 requires only a single spring member 182 as second electrical connector 200 is a single-bay connector. The steps involved in connecting cable 30 to second electrical connector 200 are exactly the same as the steps involved in connecting cables 20A, 20B to first electrical connector 100.

With reference to FIGS. 5A-8B, first and second connector interfaces 140, 240 together define parts of a push-fit connector interface system 350.

First connector interface 140 comprises a first blade housing 145 housing resiliently biased first elongate electrically conductive connector blade 142 defining a first planar lateral engagement surface 144 with a rectangular side profile and rectangular cross-sectional profile. Second connector interface 240 comprises a second blade housing 245 housing a second elongate electrically conductive connector blade 242 defining a second planar lateral engagement surface 244 with a rectangular side profile and rectangular cross-sectional profile substantially corresponding to those of the first elongate electrically conductive connector blade 142.

Second blade housing 245 has a plug profile 352A and first blade housing 145 has a socket profile 352B for slidably receiving the plug profile 352A of the second blade housing 245 along a mating axis corresponding to longitudinal axis “C” defined by first elongate electrically conductive connector blade 142.

As illustrated in FIGS. 6A-C, the first and second blade housings 145, 245 are configured to engage as the first and second electrical connector modules 100, 200 move from the disconnected configuration to an engagement configuration, the engaged configuration being an intermediate configuration between the disconnected configuration and the connected configuration in which the first and second lateral engagement surfaces 144, 244 engage to form an electrical connection.

With reference to FIGS. 8A and 8B, first blade housing 145 comprises an open chamber 145A housing the first blade member 142 with a side channel 145B adjacent the first blade member 142 for slidably receiving a tip of the second blade member 242 of the second connector interface 240.

Side channel 145B is configured to permit entry of the tip of the second blade member 242 alongside the first blade member 142 such that the first and second later engagement surfaces 144, 244 engage whilst displacing (by flexure of the tip of the resiliently biased first blade member) the first blade member 142 from its undisplaced position.

As shown, first blade housing 145 further defines a sloped guide surface 145C positioned at an entrance to the side channel 145B to guide the tip of the second blade member 242 into the side channel 145B.

First and second blade housings 145, 245 further comprise quick-release interengageable hook and catch snap-fit profiles 145A, 245A configured to maintain a mechanical connection between the first and second electrical connector modules 100, 200.

In use, cables 20A, 20B may be installed in first electrical connector module 100 as described and the lids 160 closed to secure the cables. Cable 30 may be installed in second electrical connector module 200 in the same manner. Once the cables are connected the first and second connector modules 100, 200 may be coupled by engaging first and second connector interfaces 140, 240 of the push-fit connector interface system 350.

In this way, a fast screwless lever-clamp connector module 100, 200 is provided with lid for use as a junction box for connecting lighting (e.g. LED lighting) and other electrical devices. Advantageous, the modular system is safe and fast to use offering a significant reduction in termination time.

In one embodiment, electrically insulative housing 110, 210 of each of the first and second electrical connector modules 100, 200 and their associated lids 160, 260 may be formed from a transparent material to assist insertion/inspection of the cables to be terminated.

In another embodiment, the connection terminals 170 may be colour-coded to simply connection of the appropriate conductors to the correct connection terminal.

1. An electrical junction box comprising:
a housing defining a chamber with an entry port for receiving an electrical cable; and
at least one connection terminal provided within the chamber and configured to engage an exposed conductor end of the electrical cable, the at least one connection terminal comprising a clamping mechanism for connecting a conductor of the electrical cable to the electrical junction box;
wherein the housing comprises a main body portion and a lid movably coupled to the main body portion, the main body portion and the lid together forming the chamber and the entry port, the lid being movable relative to the main body portion from an open position in which the chamber is accessible and a closed position in which the chamber is covered, wherein movement of the lid from the open position to the closed position causes the clamping mechanism to clamp the exposed end of the electrical cable.

2. An electrical junction box according to claim 1, wherein:
the chamber comprises first and second opposed end walls, wherein the second end wall defines at least one terminal aperture configured to receive an exposed conductor end of an electrical cable and the first end wall defines the entry port; and
the entry port defines an entry port axis and the at least one terminal aperture defines a conductor insertion axis.

3. An electrical junction box according to claim 2, wherein the conductor insertion axis of the at least one aperture is inclined relative to the entry port axis.

4. An electrical junction box according to claim 1, wherein the clamping mechanism comprises:
a frame; and
a spring member mounted on the frame.

5. An electrical junction box according to claim 2, wherein the chamber includes a cable sleeve lock provided adjacent to the first end wall.

6. An electrical junction box according to claim 5, wherein the cable sleeve lock comprises a pair of laterally spaced resiliently biased gates provided on opposed sides of the entry port axis.

7. An electrical junction box according to claim 2, wherein:
the at least one connection terminal comprises a plurality of connection terminals, each connection terminal comprising a separate clamping mechanism for connecting a separate conductor of the electrical cable to the electrical junction box; and
the movement of the lid from the open position to the closed position causes each of the clamping mechanisms to clamp an exposed end of the electrical cable received in its respective connection terminal.

8. An electrical junction box according to claim 7, wherein the at least one terminal aperture comprises a plurality of separate terminal apertures each associated with a different one of the plurality of connection terminals.

9. An electrical junction box according to claim 1, wherein the lid and main body portion have interengageable snap-fit profiles.

10. An electrical junction box according to claim 1, wherein the chamber defines a first connection bay for receiving a first electrical cable and the housing defines a second chamber with a second entry port for defining a second connection bay for receiving a second electrical cable, the second chamber being formed by the main body and a second lid.

11. An electrical junction box according to claim 1, wherein the electrical junction box is a two-part junction box, wherein the housing and the at least one connection terminal are provided in a first junction box part and the first junction box part is connectable to a second junction box part by a connector interface system.

12. An electrical connector module comprising:
a housing defining a chamber with an entry port for receiving an electrical cable;
a connector interface for mating with a complementary connector, the connector interface comprising an electrically conductive connector element for engaging a corresponding connector element of the complementary connector; and
at least one connection terminal provided within the chamber and configured to engage an exposed conductor end of the electrical cable and provide an electrical connection between the electrical cable and the connector interface, the at least one connection terminal comprising a clamping mechanism for connecting a conductor of the electrical cable to the electrical connector module;
wherein the housing comprises a main body portion and a lid movably coupled to the main body portion, the main body portion and the lid together forming the chamber and the entry port, the lid being movable relative to the main body portion from an open position in which the chamber is accessible and a closed position in which the chamber is covered, wherein movement of the lid from the open position to the closed position causes the clamping mechanism to clamp the exposed end of the electrical cable.

13. An electrical connector module comprising:
a housing;
a connector interface for mating with a complementary connector, the connector interface comprising an electrically conductive connector element for engaging a corresponding connector element of the complementary connector; and
a connection terminal provided within the housing and configured to engage an exposed conductor end of an electrical cable and provide an electrical connection between the electrical cable and the connector interface;
wherein the connection terminal comprises a clamping mechanism including:
a frame; and
a spring member mounted on the frame;
wherein the electrically conductive connector element of the connector interface is integrally formed as part of the frame.

14. An electrical connector module according to claim 13, wherein the spring member comprises first and second arms connected by a central folded section.

15. An electrical connector module according to claim 14, wherein the frame comprises an upright wall defining an aperture for receiving the exposed end of the conductor to be clamped, wherein the aperture is configured to receive end portions of one or more of the first and second arms of the spring member.

16. An electrical connector module according to claim 15, wherein the frame comprises a longitudinal surface extending from the upright wall for engaging the first arm of the spring member.

17. An electrical connector module according to claim 13, wherein the electrically conductive connector element extends from one lateral side of the frame.

18. An electrical connector module according to claim 13, wherein the electrically conductive connector element is a blade member defining a longitudinal axis.

19. An electrical connector module according to claim 13, wherein the clamping mechanism comprises a second spring member mounted on the frame.

20. An electrical connector module according to claim 19, wherein the frame comprises first and second upright walls extending in opposed directions from a central hub, each of the first and second upright walls define an aperture for receiving exposed conductor ends of first and second electrical cables respectively.

21. An electrical connector module according to claim 20, wherein the central hub defines first and second opposed longitudinal surfaces and the electrically conductive connector element extends from the central hub.

22. An electrical connector module according to claim 20, wherein the hub defines a recess for coupling the frame to the housing.

23. An electrical connector system comprising:
a first electrical connector part defining a first connector of a connector interface system and a second electrical connector part defining a second connector of the connector interface system;
wherein:
the first connector comprises a first blade member defining a first lateral engagement surface and the second connector comprises a second blade member defining a second lateral engagement surface, the first and second connectors being configured such that the first and second lateral engagement surfaces engage one another as the first and second connectors move from an disconnected configuration to a connected configuration.

24. An electrical connector system according to claim 23, wherein the first blade member is a resiliently biased blade member.

25. An electrical connector system according to claim 24, wherein the first connector comprises a first blade housing for housing the first blade member.

26. An electrical connector system according to claim 25, wherein the first blade housing comprises an open chamber housing the first blade member with a side channel adjacent the first blade member for slidably receiving a tip of the second blade member of the second connector.

27. An electrical connector system according to claim 26, wherein the side channel is configured to permit entry of the tip of the second blade member alongside the first blade member whilst displacing the first blade member from its undisplaced position.

28. An electrical connector system according to claim 27, wherein the first blade housing further defines a guide surface positioned at an entrance to the side channel to guide the tip of the second blade member into the side channel.

29. An electrical connector system according to claim 25, wherein the second connector comprises a second blade housing for housing the second blade member, wherein the first and second blade housing are configured to engage as the first and second connectors move from the disconnected configuration to an engagement configuration.

30. An electrical connector system according to claim 29, wherein the first and second blade housings further comprise interengageable snap-fit profiles configured to maintain a mechanical connection between the first and second electrical connector parts.
